(19) United States
(12) Patent Application Publication
(10) Pub. No.: US 2026/0128867 A1
(43) Pub. Date: May 7, 2026

(54) Secure Communications Among Multiple Entities Using Quantum Entanglement

(71) Applicants: Peter Burton BORDOW, Fountain Hills, AZ (US); Michael Erik MEINHOLZ, Charlotte, NC (US); Tahereh REZAEI, Charlotte, NC (US); Bradford A. SHEA, Mint Hill, NC (US)

(72) Inventors: Peter Burton BORDOW, Fountain Hills, AZ (US); Michael Erik MEINHOLZ, Charlotte, NC (US); Tahereh REZAEI, Charlotte, NC (US); Bradford A. SHEA, Mint Hill, NC (US)

(21) Appl. No.: 18/901,704

(22) Filed: Sep. 30, 2024

(51) Int. Cl. H04L 9/08; H04B 7/185

(52) U.S. Cl. CPC H04L 9/0852; H04B 7/18517; H04L 2209/80

(57) ABSTRACT

Systems and techniques may generally be adapted for establishing secure communications with use of quantum entanglement, including via the use of mesh networks and multiple satellite communication locations. An example technique may include generating a stream of quantum entangled particles, and transmitting at least part of the stream of the quantum entangled particles to at least a first node, a second node, and an intermediate node connected via a satellite communication network. In this context, the intermediate node is located between the first node and the second node, and a secure trusted mesh of entities can be established among the first, second, and intermediate nodes. The stream of the quantum entangled particles can used to derive a quantum entangled value, such as for use with a cryptographic protocol of secure communications between the first node and the second node via the satellite communication network.

### BACKGROUND

Quantum entanglement is a phenomenon where two or more particles become linked in such a way that the state of one particle instantaneously influences the state of the other, regardless of the distance separating them. When a measurement is made on one entangled particle, the measurement result can predict the outcome of a similar measurement on the other particle. Entanglement is utilized in quantum cryptography applications, often as a secure source of random numbers.

A variety of applications are being researched in the area of quantum cryptography to improve secure communications, such as to develop and deploy cryptographic protocols that use quantum entanglement as a source of randomness. However, one technical challenge with the use of quantum entanglement is that many experimental scenarios involving secure communications are limited to direct communications between two parties, based on line-of-sight transmissions of quantum entangled particles.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a system to distribute a stream of entangled photons to a first location and a second location in a computing network, in accordance with some examples.

FIG. 2 illustrates an arrangement of a satellite-based communication network, configured to use quantum entanglements for establishing a chain of trusted entities, in accordance with some examples.

FIG. 3A illustrates a satellite-based communication network using multi-way streams of quantum entanglement among multiple entities, in accordance with some examples.

FIG. 3B illustrates a satellite-based communication network using entanglement swapping for quantum entanglement among multiple parties, in accordance with some examples.

FIG. 4A illustrates modification of a cryptographic algorithm, in accordance with some examples.

FIG. 4B illustrates modification of control flow within a program, in accordance with some examples.

FIG. 5 illustrates a flowchart showing a technique for establishing secure communications with quantum entanglement, in accordance with some examples.

FIG. 6A illustrates a flowchart showing a technique for determining a quantum entangled value based on multi-way streams of quantum entanglement among multiple entities, in accordance with some examples.

FIG. 6B illustrates a flowchart showing a technique for determining a quantum entangled value based on entanglement swapping among multiple entities, in accordance with some examples.

FIG. 7 illustrates a node including components for communication, generation of cryptographic data, quantum data, storage, and processing in accordance with some examples.

FIG. 8 illustrates generally an example of a block diagram of a computing machine upon which any one or more of the techniques discussed herein may perform in accordance with some examples.

### DETAILED DESCRIPTION

The following introduces approaches for establishing quantum entanglement among multiple entities, to increase the number of entities that can be involved in transmitting information and to introduce aspects of quantum networking into long-distance networks such as satellite communication networks. Approaches are disclosed for establishing a trusted chain of quantum entangled entities, allowing a set of two or more entities to establish a trusted and secure communication state with one another. In some examples, the trusted chain of quantum entangled entities may be established with the use of quantum entanglement, which can be used to grow a trusted chain of entities. At different portions of the trusted chain of entities, two entities can obtain a random value from the quantum entanglement to establish secure communications with each other—even if there may be one or more intermediate entities and/or a large distance between one another.

The following introduces approaches that establish and use quantum entanglement by transmitting quantum-entangled information such as a stream of photons. Among other use cases, this enables the trusted chain of quantum-entangled entities to be established among more than two nodes at distant locations, such as among satellites located in a multi-satellite mesh (e.g., a low-earth orbit (LEO) satellite constellation). This trusted chain of entities may be accomplished from the use of independent quantum entanglements or relayed quantum entanglements between sets of satellites in the mesh, between sets of satellites in different constellations, between a satellite and a ground station, and other combinations. In some examples, quantum entanglement can be used to provide the same random number to a first node and a second node in a computing network—even if there are multiple entities and intermediate nodes or network connection points located between the two nodes.

Although quantum entanglement presents a great opportunity to securely distribute a random number to two entities, the quantum physics properties of entanglement present a significant challenge. As a simplified explanation, by entangling photons at a common photon source and sending one photon stream to the first node, and the other photon stream to the second node, a measurement at both nodes of the received photon streams can generate a string of binary values that can be used as a random number. Any eavesdropping of either photon stream is detectable because the quantum state is destroyed from observation of the photon streams. This random number can be used as a seed to a cryptographic protocol, used to modify a program with changes in an encryption/decryption processes, used to dynamically execute conditional code or change parameters within program code, or used to change how data within a program is stored, as basic examples.

In cryptographic systems, the generation of strong asymmetric public/private key pairs is critical for secured communications, especially in financial transactions. Public key infrastructure (PKI) underpins various security protocols, such as TLS, IPsec, etc., ensuring the confidentiality and integrity of data exchanged over potentially insecure networks. However, traditional key generation methods face challenges because the keys may be based on numbers that are not as random as they may appear. Increasing computational power and the emergence of quantum computing could render current asymmetric algorithms vulnerable to attacks. Additionally, the secure distribution and management of keys remain challenging, as any compromise in the key exchange process can lead to key compromise, counterfeit identities, unauthorized access, and data breaches. Protecting against current and future threats for maintaining the security of digital communications requires solutions that address such challenges. Thus, there is a need for improved quantum-resistant cryptographic techniques, especially among entities located long distances from each other—especially if geographically separated such as when located on other continents with many intermediate network connection points.

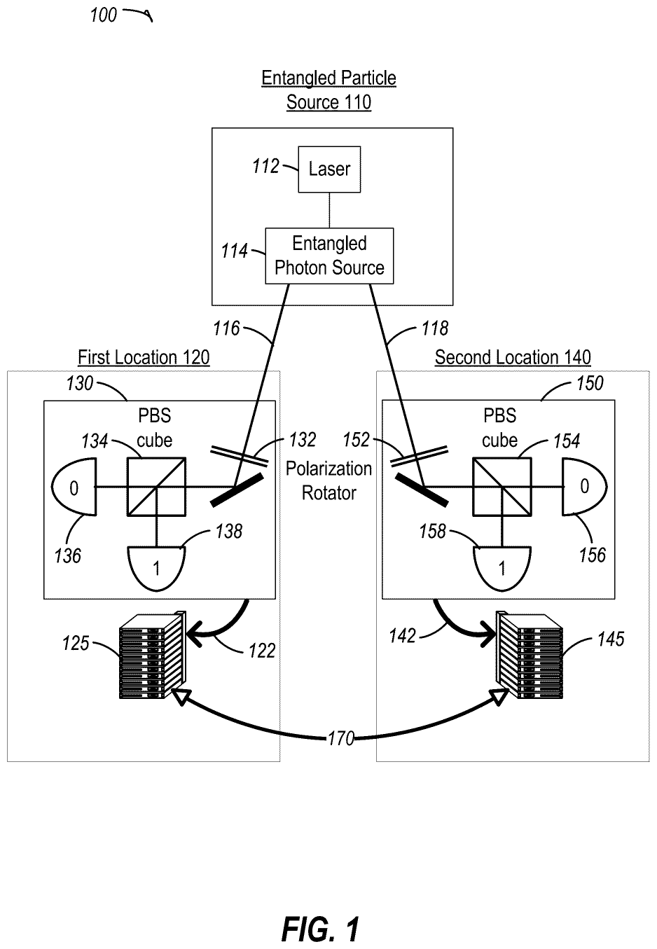

FIG. 1 illustrates a simplified example system 100 to distribute a stream of entangled particles to a first location and a second location in a computing network in accordance with some examples. The system 100 may include an entangled particle source 110, a first location 120 (e.g., a first location hosting a computing node or system), and a second location 140 (e.g., a second location hosting another computing node or system). In this simplified arrangement, the entangled particle source 110 is located outside of the first location 120 and the second location 140; however, other arrangements as discussed below may involve co-location of the entangled particle source 110 at (or near) the first location 120 (and/or the second location 140), or in a configuration where the entangled particle source 110 provides the photon stream to the first location 120, then to an intermediate node, then to the second location 140, etc.

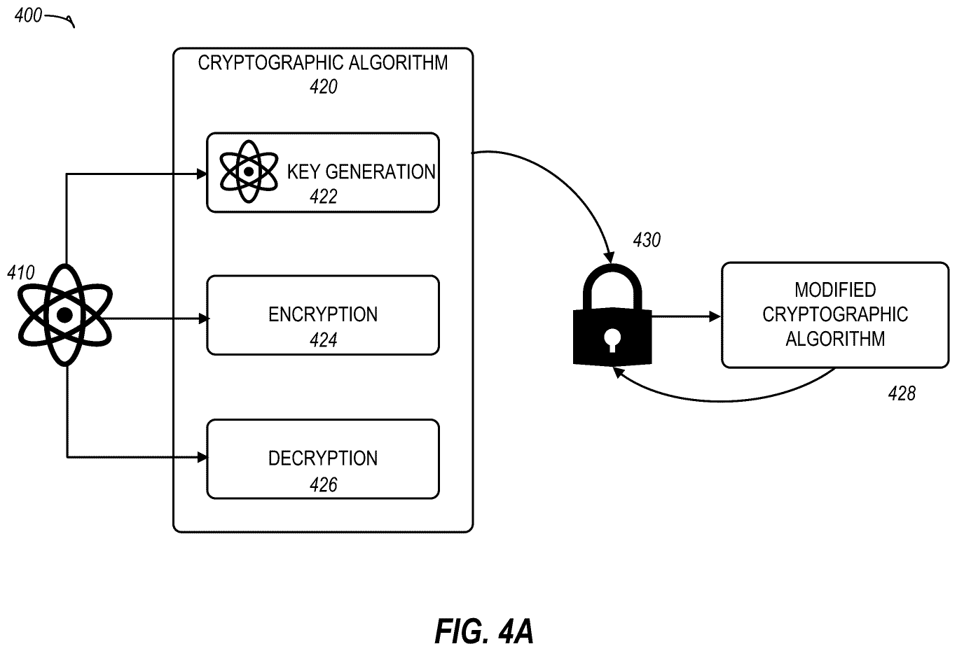

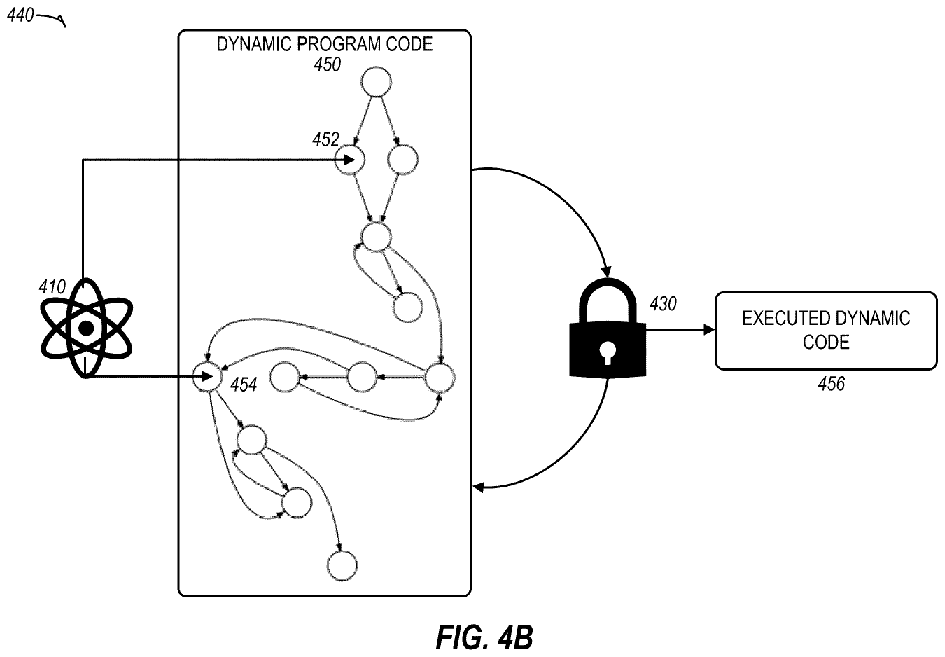

In some examples, the system 100 may be configured to implement a specific quantum cryptography protocol for quantum key distribution, such as the BB92 Protocol, the Ekert protocol (E91), or modifications of such protocols (e.g., an extension of E91 that uses multipartite entangled states such as Greenberger-Horne-Zeilinger (GHZ) states). The use of quantum entanglement to deliver correlated photon streams to two measurement entities (observers) is leveraged in quantum key distribution. Additionally, the measurement results at the first location 120 and second location 140 can provide a seed for generating random numbers at the end stations where the measurements occur. In this way, a second property of quantum mechanics can be applied in the system 100. That is, by using the randomness inherent when generating subsequent pairs of entangled particles, the quantum entangled particles can be a seed for generating random numbers at the first location 120 and second location 140 after the distribution of quantum entangled particles. Random numbers derived from a quantum seed are often used as ‘keys’ in cryptographic algorithms, and may be used for any suitable purposes, as detailed below with reference to FIGS. 4A-4B.

In general, quantum cryptography protocols can include (i) distribution of quantum entangled particles, (ii) measurement of one or more of the quantum entangled particles, and (iii) analysis of the measurement results. Analysis of the measurement results (e.g., via one or more computers in communication over a network, such as communication channel 170) can provide an indication that the distribution of quantum entangled particles was not interrupted, and that the distribution is a trusted, secure quantum communication channel. Once the trusted quantum communication channel is established, the quantum entangled particles can be used for additional capacities such as creating streams of binary numbers.

In some examples, the system 100 may include any other suitable configurations, such as the entangled particle source 110 and the first location 120 being co-located, such as in the BB84 quantum cryptography protocol. The system 100 may include any suitable additional devices or devices to generate quantum entangled particles, perform measurements on quantum entangled particles, or otherwise implement a cryptography protocol that distributes quantum entangled particles and that generates random numbers from a quantum-derived seed at a first node and at a second node.

The entangled particle source 110 may produce entangled photon pairs and may include a laser 112 and an entangled photon source 114. In some examples, the laser 112 may be any suitable laser, such as a continuous wave laser or a pulsed laser. The laser 112 may have any suitable wavelength (tunable or fixed), bandwidth, and output power. The laser 112 may have any suitable coherence length and may be selected to have certain output features (center wavelength, bandwidth, pulse length, coherence length, etc.) that are required for an implementation of the entangled photon source 114 to produce a suitable pair of entangled photons 116 and 118.

In some examples, the entangled photon source 114 may be any suitable physical device that outputs the pair of entangled photons 116 and 118. Photons output by the entangled photon source 114 may be entangled across any suitable physical characteristic, such as phase, polarization, wavelength, arrival time, etc. The output photon pair (the entangled photons 116 and 118) may be described (e.g., using a mathematical representation such as bra-ket notation of the quantum state) with any suitable quantum entangled state, such as a Bell state, a “cat” state, a squeezed state, or any other suitably described quantum mechanical superposition that may be necessary to carry out a selected quantum cryptography protocol.

In some examples, the entangled photon source 114 may produce the entangled photons 116 and 118 that are coupled into transmission fibers for delivery to the first location 120 and the second location 140. In some examples, the entangled photon source 114 may produce the entangled photons 116 and 118 that are delivered through free-space propagation to the first location 120 and the second location 140. Note that the entangled photon source 114 may be replaced with any suitable device that produces pairs of entangled particles other than the pair of entangled photons 116 and 118. For example, the entangled particles may be pairs of ions (e.g., trapped ions, ion beams), pairs of electrons, pairs of qubits (e.g., superconducting qubits, solid state qubits) that are stationary and may be entangled or whose entanglement may be transported through any suitable device or medium, etc.

In another example, the entangled photon source 114 may instead be (or in addition be used with or include) a source of entangled electrons. In this example, each of the measurement devices 130 and 150 may include a wire grid polarizer that is sensitive to (e.g., transmits, absorbs, rotates, etc.) a particular spin orientation of incoming electrons, and may include a particle detector.

In an example computing arrangement, the first location 120 may include the measurement device 130 and a server 125, as one photon 116 of the entangled pair is delivered to measurement device 130 from the entangled photon source 114 for use in a cryptographic process with the server 125. The second location 140 may include a measurement device 150 and a server 145 may have one photon 118 of the entangled pair delivered to measurement device 150 from the entangled photon source 114 for use in a corresponding cryptographic process with the server 145. This cryptographic process may include establishing a secure communication channel or communicating secure data between the server 125 and the server 145 over the communication channel 170.

Measurement device 130 and measurement device 150 at the respective locations may include substantially similar components. Measurement device 130 may include a polarization rotator 132, a mirror, a polarizing beam splitter (PBS) 134, a detector 136 at the transmission port of the PBS (“0”), and a detector 138 at the reflection port of the PBS (“1”). Measurement device 150 may include a polarization rotator 152, a mirror, a polarizing beam splitter (PBS) 154, a detector 156 at the transmission port of the PBS (“0”), and a detector 158 at the reflection port of the PBS (“1”). As shown in FIG. 1, a photon pair including entangled photons 116 and 118 emitted from the entangled photon source 114 is transmitted (e.g., free-space, fiber optic, etc.) to two nodes. Specifically, one photon of the pair of entangled photons 116 is transmitted to the first location 120 and the other photon of the pair of entangled photons 118 is transmitted to the second location 140. In the example of FIG. 1, the pair of entangled photons 116 and 118 are entangled through the polarization of each photon, thus the measurement device 130 and measurement device 150 at each node are configured to measure polarization. In the example of FIG. 1, measurement device 130 and measurement device 150 include components that are used to implement the E91 cryptography protocol. For implementation of any other suitable cryptography protocol, additional components may be included in measurement device 130 and measurement device 150.

Note that, as shown in FIG. 1, the server 125 and the server 145 may already be in communication with each other, as shown by communication channel 170, which may be any suitable wired or wireless communication channel such as the Internet or a public/private network. In some examples, results of the measurements at measurement device 130 and measurement device 150, as well as additional analysis to check for disruptions to the quantum entangled photon pairs (e.g., through a measurement of one of the photons prior to measurements at measurement devices 130 and measurement devices 150) may be communicated. In some examples, a portion of the measurements recorded at measurement device 130 and measurement device 150 may be used as random numbers.

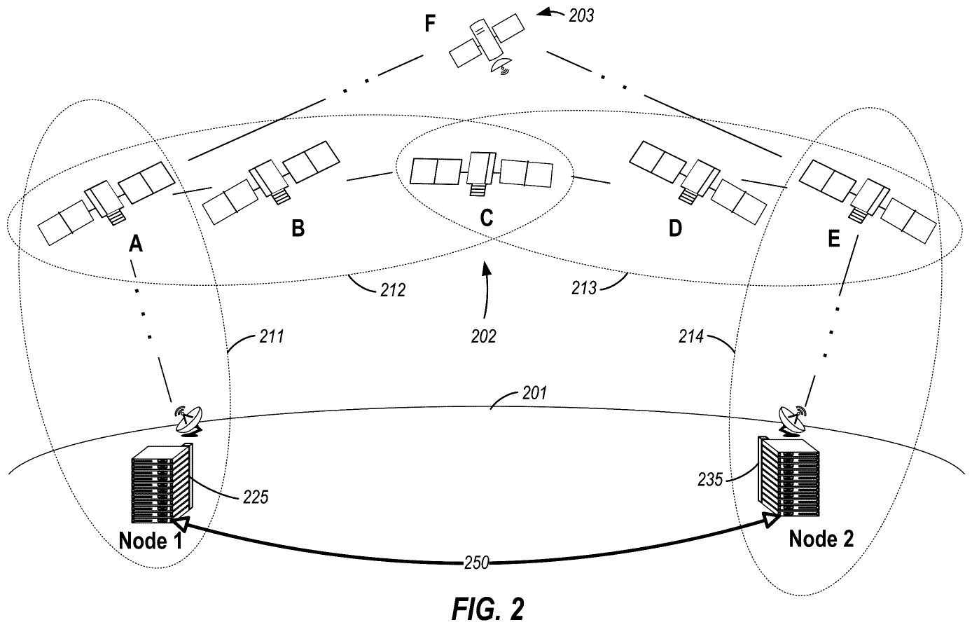

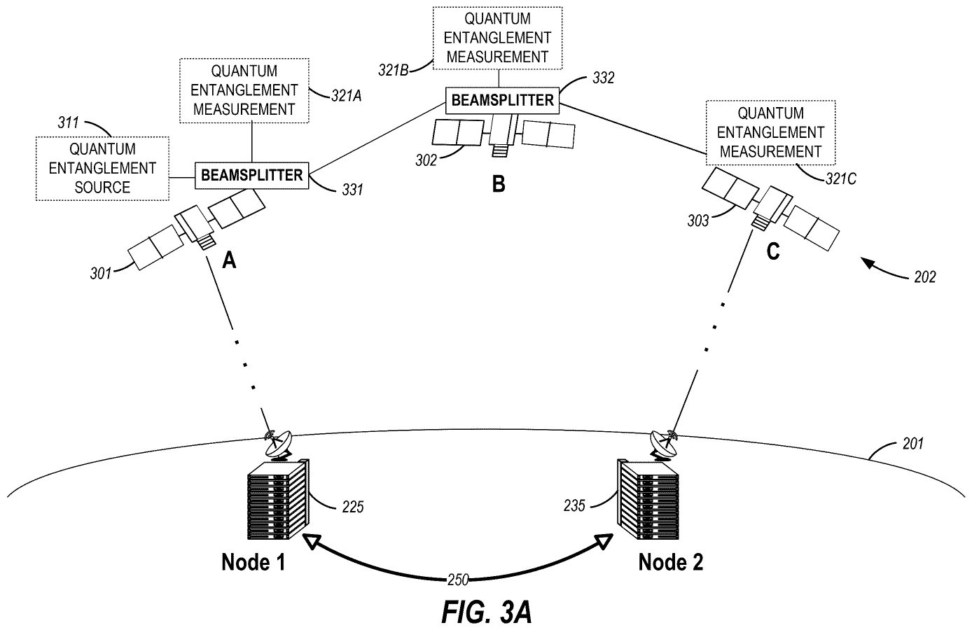

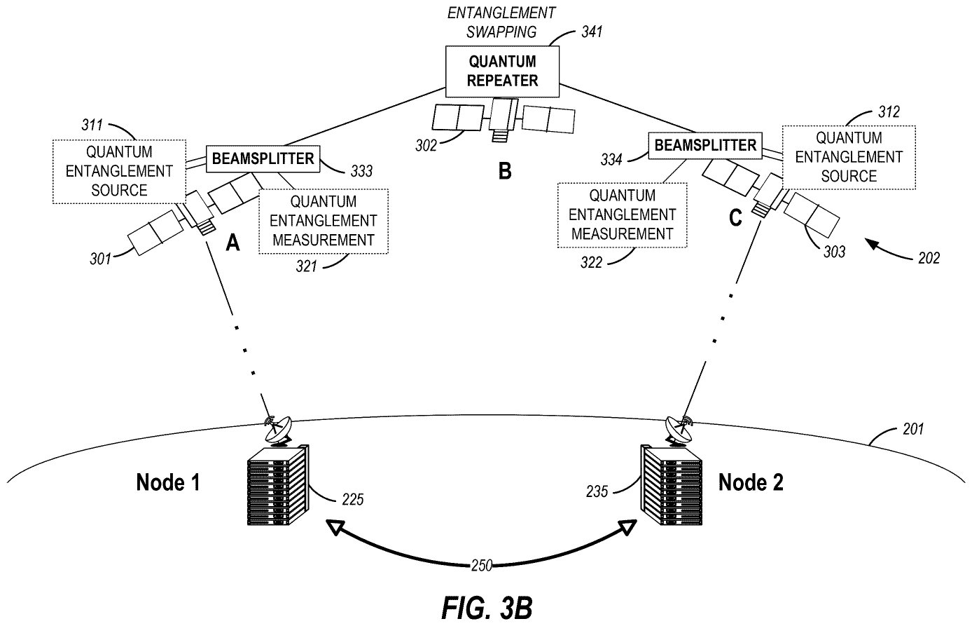

In various examples, the first location 120 and the second location 140 can be located at any suitable distance apart from each other. For example, the first location 120 may be located at a data center and the second location 140 may be located at a corporate office in a metropolis. Additionally, portions of the first location 120, such as measurement device 130 and server 125, may be distributed at multiple locations and may be in communication with each other through any suitable wired or wireless communication. Similarly, portions of the second location 140, such as measurement device 150 and server 145, may be distributed at multiple locations, or at multiple workstations within a single location. In another example, at least one of the first location 120 and the second location 140 may be located on an artificial satellite, while the other node may be located at a terrestrial station in communication with the artificial satellite. Additional examples of hosting the quantum entangled locations in a satellite communication network are discussed below in reference to FIGS. 2 to 3B.

FIG. 2 illustrates an example arrangement of a satellite-based communication network, configured to use quantum entanglements for establishing a chain of trusted entities, according to an example. This chain of trusted entities (also referred to as a “trust chain”) is established among ground stations and compute nodes located on Earth 201, and among artificial satellites and compute equipment located in a satellite constellation 202.

In some examples, the satellite constellation 202 may operate in a low earth orbit (LEO), which includes orbits that are at or below 2,000 kilometers above the Earth's surface (with some having a higher apogee). In other examples, the satellite constellation 202 (or the satellite in a stationary satellite orbit 203 as discussed below) may operate in a medium earth orbit (MEO), which includes orbits above 2,000 kilometers up to around geosynchronous orbit (e.g., around 35,000 to 36,000 kilometers), a geosynchronous orbit (e.g., an orbit that rotates at the same rate as the Earth, enabling a satellite to remain stationary with respect to a location on Earth), or high earth orbit (HEO) (e.g., an orbit that generally exceeds geosynchronous orbit).

The trust chain can be established through one or more groups/sets of quantum entanglements and communications of information from quantum entanglement. The trust chain can include multiple hops of quantum entanglement, to transmit entanglements to more than one node. Each instance of quantum entanglement that is used between a respective start node and a respective end node is referred to as a “group”, shown in this example with group 211, group 212, group 213, and group 214. As shown in FIG. 2, an end-to-end chain of trusted entities may be established by linking quantum-entangled groups that overlap—establishing a trusted relationship between group 211, group 212, group 213, and group 214. Each group includes two or more entities (nodes) in which quantum entanglement is used to establish a secure connection, and groups 212, 213 specifically include more than two entities. Approaches for linking more than two entities (nodes) with quantum entanglement are specifically depicted in FIGS. 3A and 3B.

In the example of FIG. 2, a first group 211 establishes a first “link” of the trust chain, based on quantum entangled communications provided between ground node 1 and Satellite A; a second group 212 may establish a second link of the trust chain, based on quantum entangled communications provided between Satellite A, Satellite B, and Satellite C; a third group 213 may establish a third link of the trust chain, based on quantum entangled communications provided between Satellite C, Satellite D, and Satellite E; a fourth group 214 may establish a fourth link of the trust chain, based on quantum entangled communications provided between ground node 2 and Satellite E. Because the entities of the first group 211 and the entities of the second group 212 establish a secure trust relationship—and secure communication channel—with each other, the entities of the first group 211 (such as Server 225 at Node 1) can also inherit a secure trust relationship with the entities of the second group 212 (such as Satellite C). This can be used to establish a trusted, secure communication path between the first group 211 to the second group 212 to the third group 213 to the fourth group 214—enabling a trusted exchange of security credentials all the way from Server 225 at ground node 1 to Server 235 at ground node 2.

In another example, an additional or different satellite or satellite constellation may provide the quantum entangled particles, or be involved as a link in the trust chain. For example, a satellite F (e.g., located in geosynchronous/stationary satellite orbit 203) may provide quantum entangled particles to multiple entities of the satellite constellation 202 (e.g., to satellites A and E). In this scenario, the satellites then may use the approaches depicted in FIG. 3B (with multi-way streams of quantum entanglement) or FIG. 3B (with entanglement swapping) to establish trust in the trust chain among more than two entities. In other examples, the satellite F may be used as an intermediate node and is used to directly communicate a stream of quantum entangled particles between a first node (e.g., satellite A) and a second node (e.g. satellite E).

FIG. 3A illustrates a first example of a satellite-based communication network, enacting multi-way streams of quantum entanglement among multiple entities. This illustration shows how a server 225 located at a first compute node on-Earth (labeled “node 1”) and a second server 235 located at a second compute node on-Earth (labeled “node 2”) may use a chain of quantum entangled entities to derive a value, with this derived value used to establish a cryptographically secure path such as via communication path 270.

FIG. 3A further shows how a trusted chain of entities is established using quantum entanglement states communicated among three nodes A, B, and C, corresponding to satellites 301, 302, and 303. For example, a Greenberger-Horne-Zeilinger (GHZ) tripartite (three-particle) entangled state can be shared amongst the three nodes A, B, and C. That is, each of the three nodes can receive one photon of a GHZ state. In some examples, the GHZ state can be generated at node A. In some examples, the three photons can be entangled in any suitable degree of freedom, such as polarization, energy, momentum, time, path, etc. In some examples, the photons can be hyper-entangled, that is, entangled in more than one degree of freedom.

In some examples, the GHZ state can be generated using any suitable realization of multi-particle entanglement. For example, multi-photon entanglement and interferometry by Jian-Wei Pan et al., “Multi-photon entanglement and interferometry”, Rev. Mod. Phys. (20 Sep. 2011) reviews detailed mechanisms of multi-photon entanglement, both in theory and experimental realizations. Pan et al. in its FIG. 16 provides an experimental setup for observing three-photon GHZ entanglement. The experimental setup therein includes transforming 4 photons that have two-way entanglement, that is, two pairs of polarization entangled photons, into an entangled state of 3 photons with the fourth photon serving as a trigger photon. The pairs of polarization entangled photons can be generated as discussed above in reference to FIG. 1.

Similar to the setup of Pan et al., the quantum entanglement source 311 in the scenario of FIG. 3A generates a three-way entangled photon state (at first node A). Satellite 301 includes a quantum entanglement source 311, a measurement device 321A (such as measurement device 130 as discussed above in FIG. 1), and a beamsplitter 331. The three-way entangled photon state can be understood as three streams of photons to be delivered to each respective satellite, e.g. through beamsplitters.

At the first node A (at satellite 301), beamsplitter 331 selects a first photon of the tripartite entangled state to be measured at the measurement device 311A. In some examples, based on how quantum entanglement source 311 produces the tripartite entanglement state (e.g., co-linear photons, time-delayed photons, etc.) the beamsplitter 331 can alternatively be a mirror, a phase plate, and/or any other suitable optic that can select one photon to be measured. At the other output of beamsplitter 331, the remaining two photons in the tripartite entanglement state are provided to an intermediate node B (at satellite 302). The intermediate node B (at satellite 302) also uses a beamsplitter 332 to select a second photon of the tripartite state. This second photon is measured at measurement device 311B. The remaining photon of the tripartite state is then sent to a measurement device 311C at the second node C (at satellite 303).

In some examples, any suitable additional optics, such as time-delay loops (e.g., fiber optical delay lines) can be used to synchronize the measurements of each of the three photons at 311A, 311B, and/or 311C. In some examples, only one or two of measurement devices 311A, 311B, and/or 311C can perform measurements on a respective photon in the tripartite entanglement state. That is, based on this distribution of the quantum-entangled particles, a measurement can occur at the first node A (at satellite 301) and a measurement can occur at the second node C (at the satellite 303). No observation occurs at the intermediate node B. When this measurement occurs (at 321A and 321C), some quantum-derived value can be securely obtained at the first node A and the second node B.

FIG. 3B illustrates a second example of a satellite-based communication network, using entanglement swapping for quantum entanglement among multiple entities. Similar to the scenario of FIG. 3A, a trust chain is established in satellite constellation 202. The arrangement is used to establish a cryptographically secure path between the server 225 and the server 235 (including to establish security for use of another communication channel such as via communication path 250).

The scenario of entanglement swapping in FIG. 3B involves the use of multiple quantum entanglement sources, such as a first quantum entanglement provided from quantum entanglement source 311, and a second quantum entanglement provided from quantum entanglement source 312. A beamsplitter 333 and a beamsplitter 334 are used to provide the stream of quantum entangled particles from each source in two directions: towards a repeater 341 and towards a respective measurement device 321, 322. The repeater 341 performs entanglement swapping between the streams of quantum entangled particles that are locally generated at the respective entanglement sources 311, 312. Entanglement in this fashion allows the measurement devices 321, 322 to provide entangled states for a stream of particles—even though the streams of quantum particles were generated at the respective entanglement sources 311, 312.

Other scenarios may involve combinations of entanglement swapping (as depicted in FIG. 3B) and relayed quantum entanglement states (as depicted in FIG. 3A). This may enable a complex arrangement of quantum networking that performs the relays and swapping of quantum states among multiple satellite nodes and/or ground nodes.

As will be understood, the use of quantum entanglement may be used to derive a variety of values for use in cryptography, secure communications and networking, computation, and the like. In still further examples, executable code and data can be securely transmitted between terrestrial nodes and satellites using the systems and other aspects of the disclosed subject matter. By leveraging quantum entanglement and quantum cryptography techniques, algorithms may be updated on satellites, ensuring that any modifications to the code remain unpredictable and resistant to reverse engineering. This approach addresses the need for heightened security in satellite communications, which is crucial given the increasing reliance on satellites for a wide range of applications, including financial transactions and data transmission.

In further examples, a random number can be used to alter an executable program. The resulting modified program can be more secure as the modification can increase the program complexity and prevent reverse-engineering of the program. By including a random number generated from a quantum derived seed, and particularly by distributing the quantum derived seed using quantum entanglement, such modifications can be communicated across two or more nodes of a computing network.

FIG. 4A illustrates modification of a cryptographic algorithm using a random number generated from a quantum derived seed in accordance with some examples. As shown, block diagram 400 includes a random number 410, a cryptographic algorithm 420, a verification component 430, and a modified cryptographic algorithm 428.

In some examples, the random number 410 may be generated using any suitable quantum derived seed as input to a random number generator. In some examples, a quantum derived seed as input to a random number generator may exist at a first node and a second node, as described above with reference to FIGS. 1 and 2. The random number 410 generated from the quantum derived seed may be used in any sub-process of cryptographic algorithm 420, such as key generation 422, encryption 424, or decryption 426.

In some examples, key generation 422 may be performed using the random number 410. The random number itself may be the key, particularly in examples where a symmetric-key algorithm is used. In some examples, the random number may be used to generate the key for a symmetric-key algorithm such as Advanced Encryption Standard (AES), data encryption standard (DES), block ciphers, etc.

The random number 410 may be used in the encryption process(es) 424 of the cryptographic algorithm. For example, the AES encryption process generally includes byte substitution, row shifting, column mixing, and adding a round key. In some examples, the random number 410 may be used to randomly select the offset value for row shifting. In some examples, the random number 410 may be used to select or generate a polynomial used in column mixing. In some examples, the random number 410 may be used to derive the round key from the original key through any suitable key expansion process. In each of these examples, the AES decryption process may use the same random number 410 as appropriate to perform a computationally correct inverse of the byte substitution, row shifting, column mixing, and adding the round key. Such an example may be particularly effective when the encryption process is performed at a first node and the decryption process is performed at a second node, and both of the first and the second node have access to the same quantum derived seed that is input to generate the random number 410.

In another example, the key used in the encryption process (such as AES or any other suitable encryption process) may be modified. For example, the random number 410 may be combined in any suitable combination with an AES key to create a modified AES key. As a particular example, a byte-wise operation to XOR the AES key with the random number 410 can create a new random number that may be used as the modified AES key. Similarly, an AES key may be combined with the random number 410 such that the random number 410 is a tweak key in an encryption protocol, such as the XTS mode of using AES (NIST SP 800-38E) or the Format Preserving Encryption (FPE) algorithm.

Note that, when the cryptographic algorithm 420 is modified by the random number 410, verification component 430 can perform any suitable routines or processes to determine whether the functional output of the cryptographic algorithm remains the same as the unmodified version. As noted by the input arrow to verification component 430, the output of the cryptographic algorithm can be used as input to verification component 430. As indicated by the output arrow, verification component 430 can create feedback to the cryptographic algorithm 420 in the event that using the random number 410 does not preserve the functional output.

FIG. 4B illustrates modification of control flow within a program using a random number generated from a quantum derived seed in accordance with some examples. As shown, block diagram 440 includes the random number 410, dynamic program code 450, verification component 430, and the executed dynamic code 456.

Dynamic program code 450 contains a representation of control flow as nodes connected by arrows. Such control flow may include loops (e.g., for loops, while loops, do-while loops, etc.) and conditional statements (if/then, if/else, etc.). Dynamic program code 450 may also contain conditional statements to allow for decision making, may create multiple branches of logic, and may create complex decision trees when conditional statements are nested. In some examples, a branching control flow may include different implementations of a subroutine that are functionally equivalent, and the random numbers may be used to select between the functionally equivalent but structurally different implementations. In some examples, executing different branches of dynamic program code 450 may produce functionally equivalent outputs, as can be verified by the verification component 430. In particular, verification component 430 can verify (or identify a subset of all possible branches) that different branches perform equivalent operations when operated in a different sequence or using different algorithms.

As shown in FIG. 4B, at a node such as node 452, the random number 410 may be used as part of the decision making occurring at node 452. Thus, the random number 410 can contribute to dynamic code execution of the dynamic program code 450. In some examples, the random number 410 may be used to shuffle the order of independent operations within a function, such that the logical outcome of the function remains unchanged, but the execution order varies. In some examples, a first random number may be used at node 452 and a second random number may be used at node 454.

In some examples, the random number 410 can be used in any suitable operation at a node in the execution of the dynamic program code 450. For example, node 454 may require a random number to include with a message at the output (e.g., a message authentication code, MAC). In an execution of the dynamic program code 450, the valid output can have a valid MAC. In this example, the random number 410 can be a key for the MAC.

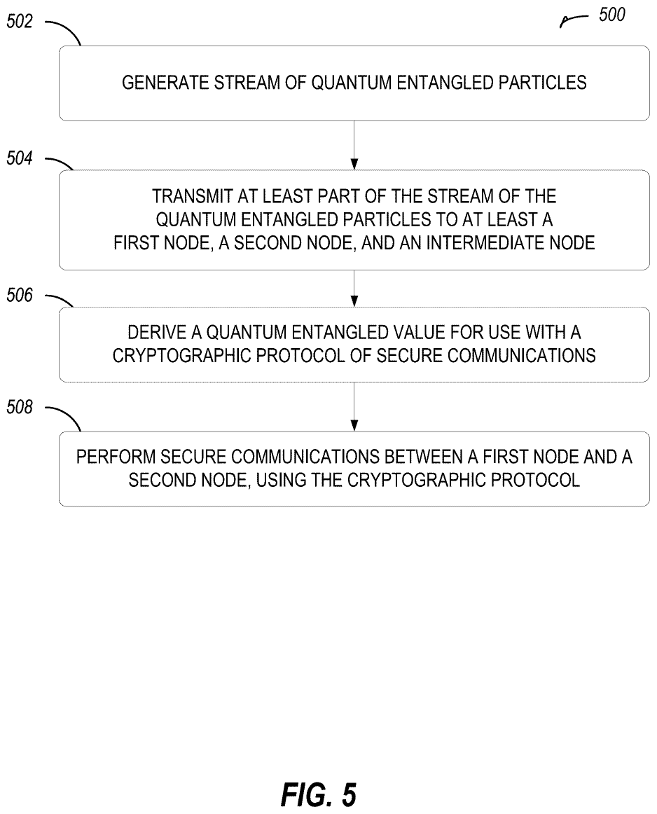

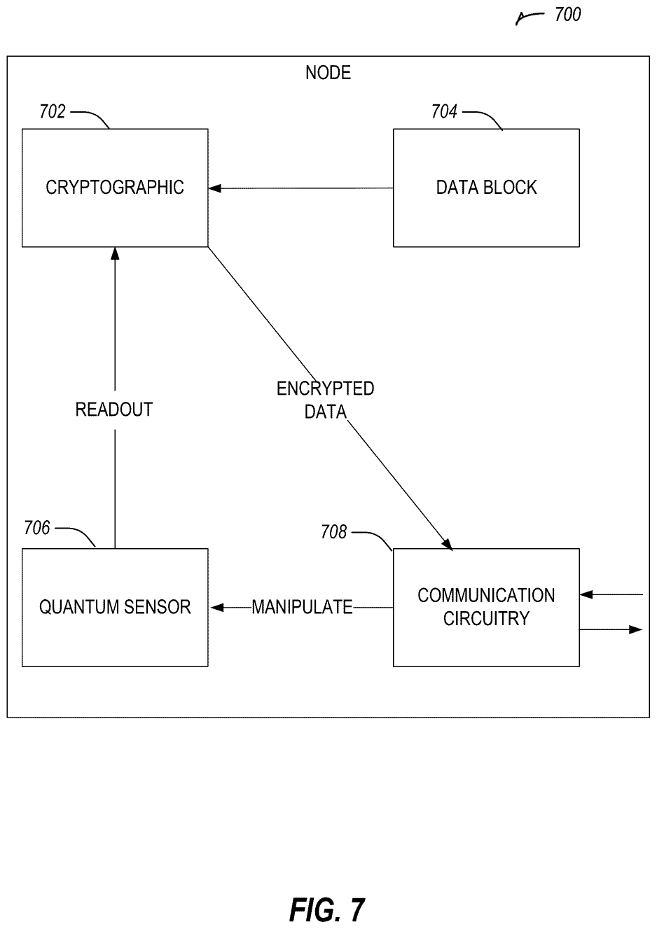

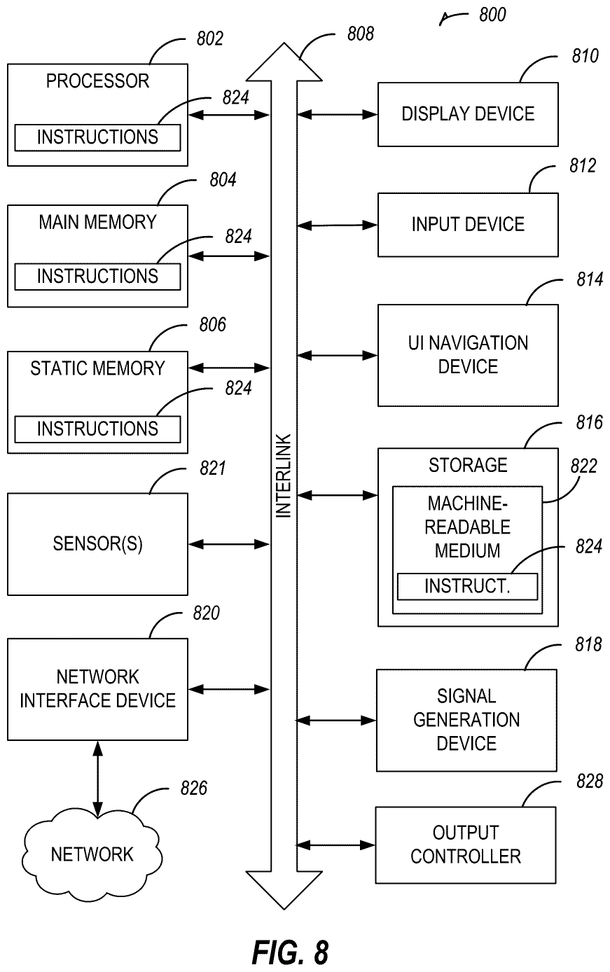

FIG. 5 illustrates a flowchart showing a technique 500 for modified quantum entangled bit communication in accordance with some examples. In an example, operations of the technique 500 may be performed by processing circuitry, for example by executing instructions stored in memory. The processing circuitry may include a processor, a system on a chip, or other circuitry (e.g., wiring). For example, technique 500 may be performed by processing circuitry of a device (or one or more hardware or software components thereof), such as those illustrated and described with reference to FIGS. 1 to 3B (e.g., server 125, server 145, server 225, server 235, quantum networking components depicted therein, etc.), FIG. 7, or FIG. 8.

The technique 500 includes an operation 502 to generate a stream of quantum entangled particles. This may be performed at one or more satellite(s), using the techniques discussed with reference to FIGS. 3A and 3B, above. This configuration of satellites may include a first node, a second node, and an intermediate node that are respective satellites in a satellite communication network. In other examples, one or both of the first node and the second node are located on-Earth and are connected to the satellite communication network.

The technique 500 includes an operation 504 to transmit at least part of the stream of the quantum entangled particles to at least a first node, a second node, and an intermediate node. In this scenario, the intermediate node is located between the first node and the second node, and is connected to each of the first node and the second node within a satellite communication network.

The technique 500 includes an operation 506 to derive a quantum entangled value for use with a cryptographic protocol of secure communications. This operation may be performed at the second node, or at another trusted connection. For instance, the quantum entangled value may be derived by an observation of the quantum entangled particles that occurs exclusively at the first node and the second node.

The technique 500 includes an operation 508 to perform secure communications between a first node and a second node, using the cryptographic protocol. This may include the use of a secure communication channel established directly between the first node and the second node, or established upstream from the first node and downstream of the second node. In an example, the cryptographic protocol includes use of a random number produced from a quantum-derived seed as input to a random number generator, where the quantum-derived seed is based on the quantum entangled value.

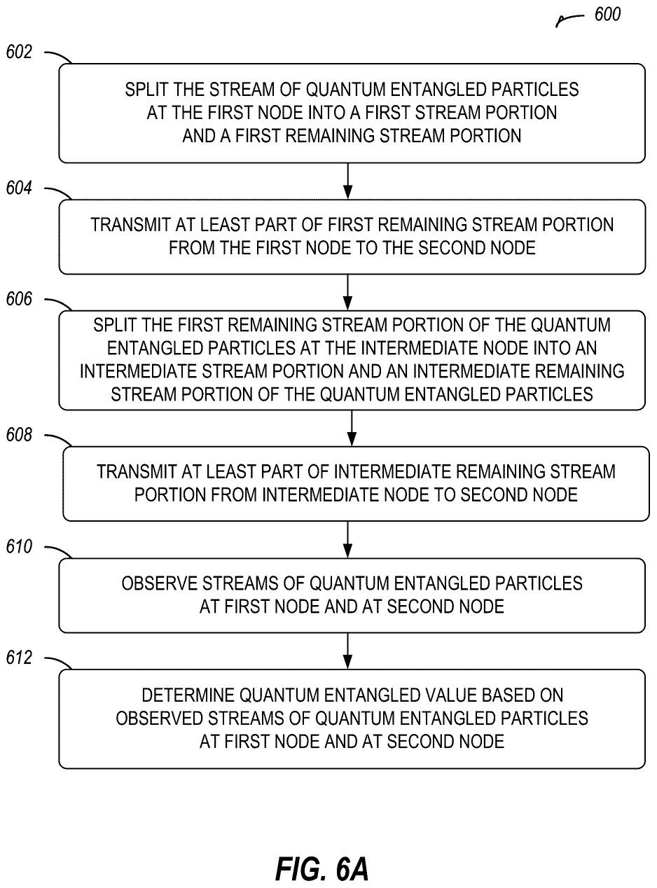

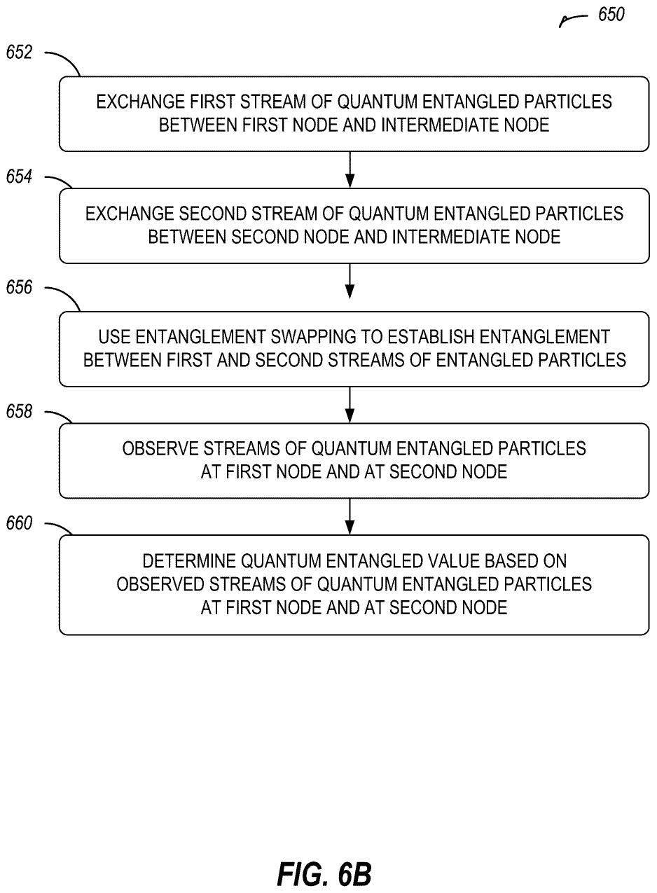

In a specific example, the technique 500 includes splitting the stream of quantum entangled particles at the first node into a first stream portion and a first remaining stream portion of the quantum entangled particles. For example, this may include an approach consistent with FIG. 3A, which is expanded in the flowchart of FIG. 6A. In another specific example, the technique 500 includes use an intermediate node configured as a quantum networking repeater. For example, this may include an approach consistent with FIG. 3B, as the quantum networking repeater uses entanglement swapping to establish an entanglement, which is expanded in the flowchart of FIG. 6B.

FIG. 6A illustrates a flowchart showing a technique 600 for determining a quantum entangled value such as a quantum derived seed (e.g., derived from quantum entangled particles) that may be used to generate a random number in connection with a cryptographic protocol. This technique 600 provides a specific implementation for multi-way streams of quantum entanglement among multiple entities, such as is depicted in and described for FIG. 3A. In an example, technique 600 may be used or integrated with any suitable additional techniques such as technique 500 as described above with reference to FIG. 5 (such as to implement operations 502, 504, and 506 with the following multi-way streams of quantum entanglement).

The technique 600 includes an operation 602 to split the stream of quantum entangled particles at the first node into a first stream portion and a first remaining stream portion. In an example, splitting the stream of quantum entangled particles at the first node includes using a first beamsplitter at the first node.

The technique 600 includes an operation 604 to transmit at least part of first remaining stream portion from the first node to the second node.

The technique 600 includes an operation 606 to split the first remaining stream portion of the quantum entangled particles at the intermediate node into an intermediate stream portion and an intermediate remaining stream portion of the quantum entangled particles. In an example, splitting the stream of quantum entangled particles at the intermediate node includes using an intermediate beamsplitter at the intermediate node.

The technique 600 includes an operation 608 to transmit at least part of intermediate remaining stream portion from the intermediate node to the second node.

The technique 600 includes an operation 610 to observe streams of quantum entangled particles at the first node and at the second node.

The technique 600 includes an operation 612 to determine quantum entangled value based on observed streams of quantum entangled particles at the first node and at the second node.

FIG. 6B illustrates a flowchart showing another technique 650 for determining a quantum entangled value such as a quantum-derived seed (e.g., derived from quantum entangled particles) that may be used to generate a random number in connection with a cryptographic protocol. This technique 650 provides a specific implementation for entanglement swapping among multiple entities, such as is depicted in and described for FIG. 3B. In an example, technique 650 may be used or integrated with any suitable additional techniques such as technique 500 as described above with reference to FIG. 5 (such as to implement operations 502, 504, and 506 with the following entanglement swapping of streams of quantum entanglement).

The technique 650 includes an operation 652 to exchange a first stream of quantum entangled particles between a first node and an intermediate node.

The technique 650 includes an operation 654 to exchange a second stream of quantum entangled particles between a second node and an intermediate node.

The technique 650 includes an operation 656 to use entanglement swapping (e.g., with a quantum repeater) to establish entanglement between a first stream and a second stream of entangled particles.

The technique 650 includes an operation 658 to observe streams of quantum entangled particles at the first node and at the second node.

The technique 650 includes an operation 660 to determine a quantum entangled value based on observed streams of quantum entangled particles at the first node and at the second node.

Further extensions of the techniques 500, 600, or 650 may include the use of a specific cryptographic protocol, such as use of a random number produced from a quantum-derived seed as input to a random number generator (e.g., where a quantum-derived seed is based on the quantum entangled value). For example, the techniques 500, 600, or 650 may be extended by having the random number generator produce the random number based on measurements of the quantum-derived seed from the quantum entangled particles (e.g., where in the first node measures a first particle in a pair of quantum entangled particles and where the second node measures a second particle in the pair of quantum entangled particles).

In further extensions of the techniques 500, 600, or 650 with a specific cryptographic protocol, the measurements of the quantum-derived seed are based on measuring a spin state for each electron in a stream of entangled electron pairs, and wherein each measurement provides a corresponding bit value of the random number. In another example, the measurements of the quantum-derived seed are based on detecting a path of single photons sent through a beamsplitter having two output paths, where detecting a first single photon at a first output path of the beamsplitter provides a first bit value of the random number, and detecting a second single photon at a second output path of the beamsplitter provides a second bit value of the random number, the first bit value being different than the second bit value. In another example, the measurements of the quantum-derived seed are based on measuring a polarization state for each photon in a stream of entangled photon pairs, and where each measurement provides a corresponding bit value for the random number. In other examples, the measurements of the quantum-derived seed are based on recording a series of arrival times of a stream of photons at a detector, and a difference or variation in arrival time between subsequent single photons provides a bit value for the random number. In other examples, the measurements of the quantum-derived seed are based on measuring decay times of a radioactive isotope, and a difference or variation in decay time between successive decay events of the radioactive isotope provides a bit value for the random number. For example, the quantum entangled particles may constitute a pair of entangled qubits, and the measurements of the quantum-derived seed are based on measuring a phase of one qubit of the pair of entangled qubits at different evolution times, and an output of measuring the phase is quantified to provide a bit value for the random number.

In an example, operations of the techniques 500, 600, or 650 may be performed, coordinated, or controlled, by processing circuitry, for example by executing instructions stored in memory. The processing circuitry may include a processor, a system on a chip, or other circuitry (e.g., wiring). For example, the techniques 500, 600, or 650 may be performed, initialized, or controlled by processing circuitry of a device (or one or more hardware or software components thereof), such as those illustrated and described with reference to FIGS. 1 to 3B, FIG. 7, or FIG. 8. Such processing circuitry may include specific controllers or components of quantum networking as discussed herein.

FIG. 7 illustrates example circuitry in a node 700 in accordance with some examples. The node 700 includes circuitry for communication, generation of cryptographic data, data from quantum effects, etc., storage, and processing circuitry. The node 700 may be on a satellite, consistent with the examples above. The node 700 shown in FIG. 7 includes cryptographic circuitry 702, which may be used to generate, check, or deduce cryptographic key information. A data block 704 may be used to store cryptographic information, such as a list of one time pads or passwords, previously stored key information, a key generation algorithm, or the like. The node 700 includes communication circuitry 708 to communicate off of the node 700. The communication circuitry 708 may be used to send a received signal to a measurement device 706, which may interpret quantum effects into a series of data (e.g., from a paired quantum bit). The measurement device 706 may send data related to the quantum effects to the cryptographic circuitry 702 (e.g., a readout of entropy, a decimal value of a quantum bit, etc. The cryptographic circuitry 702 may use the data to generate or evaluate a key. A cryptographic key may be used to generate encrypted data (e.g., a message from the data block 704) to the communication circuitry 708, which may send the encrypted data to another node.

Each measurement of a quantum entangled particle may produce a random number using any suitable process to quantify the measurement into the random number. In some examples, a stream or multiple instances of a pair of entangled particles may be used to generate the random number with a desired bit length. In an example, a random number generator of the node 700 (e.g., part of the cryptographic circuitry 702) may produce a random number based on measurements of a quantum derived seed comprising quantum entangled particles, where the node 700 measures a first particle in a pair of quantum entangled particles and where a second node measures a second particle in the pair of quantum entangled particles. In some examples, by using a pair of entangled particles, a measurement of the first particle at the node 700 may produce the same random number as a separate measurement of the second particle at the second node. This may provide a device for secure communication of random numbers to different nodes in the computing network.

FIG. 8 illustrates generally an example of a block diagram of a computing machine 800 upon which any one or more of the techniques (e.g., methodologies) discussed herein may perform in accordance with some examples. In alternative embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environment. The machine 800 may be a server computer, a personal computer (PC), a tablet PC, a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Such components are tangible entities (e.g., hardware) capable of performing specified operations when operating. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one component. For example, under operation, the execution units may be configured by a first set of instructions to implement a first component at one point in time and reconfigured by a second set of instructions to implement a second component.

Computing machine (e.g., computer system) 800 may include a hardware processor 802 (e.g., a central processing unit (CPU), a graphics processing unit (GPU), a hardware processor core, or any combination thereof), a main memory 804 and a static memory 806, some or all of which may communicate with each other via an interlink (e.g., bus) 808. The computing machine 800 may further include a display unit 810, an alphanumeric input device 812 (e.g., a keyboard), and a user interface (UI) navigation device 814 (e.g., a mouse). In an example, the display unit 810, alphanumeric input device 812 and UI navigation device 814 may be a touch screen display. The computing machine 800 may additionally include a storage device (e.g., drive unit) 816, a signal generation device 818 (e.g., a speaker), a network interface device 820, and one or more sensors 821, such as a global positioning system (GPS) sensor, compass, accelerometer, or other sensor. The computing machine 800 may include an output controller 828, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 816 may include a machine readable medium 822 that is non-transitory on which is stored one or more sets of data structures or instructions 824 (e.g., software) embodying or utilized by any one or more of the techniques or functions described herein. The instructions 824 may also reside, completely or at least partially, within the main memory 804, within static memory 806, or within the hardware processor 802 during execution thereof by the computing machine 800. In an example, one or any combination of the hardware processor 802, the main memory 804, the static memory 806, or the storage device 816 may constitute machine readable media.

While the machine readable medium 822 is illustrated as a single medium, the term “machine readable medium” may include a single medium or multiple media (e.g., a centralized or distributed database, or associated caches and servers) configured to store the one or more instructions 824. The term “machine readable medium” may include any medium that is capable of storing, encoding, or carrying instructions for execution by the computing machine 800 and that cause the computing machine 800 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 824 may further be transmitted or received over a communications network 826 using a transmission medium via the network interface device 820 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, LoRa®/LoRaWAN® LPWAN standards, etc.), IEEE 802.15.4 family of standards, peer-to-peer (P2P) networks, 3^{rd} Generation Partnership Project (3GPP) standards for 4G and 5G wireless communication including: 3GPP Long-Term evolution (LTE) family of standards, 3GPP LTE Advanced family of standards, 3GPP LTE Advanced Pro family of standards, 3GPP New Radio (NR) family of standards, among others. In an example, the network interface device 820 may include one or more physical jacks (e.g., Ethernet, coaxial, or phone jacks) or one or more antennas to connect to the communications network 826. In an example, the network interface device 820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 800, and includes digital or analog communications signals or other intangible medium to facilitate communication of such software.

The following, non-limiting examples, detail certain aspects of the present subject matter to solve the challenges and provide the benefits discussed herein, among others.

Example 1 is a method for establishing secure communications with quantum entanglement, comprising: generating a stream of quantum entangled particles ; and transmitting at least part of the stream of the quantum entangled particles to at least a first node, a second node, and an intermediate node connected via a satellite communication network, wherein the intermediate node is located between the first node and the second node; wherein the stream of the quantum entangled particles is used to derive a quantum entangled value for use with a cryptographic protocol of secure communications between the first node and the second node via the satellite communication network.

In Example 2, the subject matter of Example 1 optionally includes splitting the stream of quantum entangled particles at the first node into a first stream portion and a first remaining stream portion of the quantum entangled particles, wherein transmitting the stream of the quantum entangled particles to at least the second node includes transmitting at least part of the first remaining stream portion from the first node to the intermediate node.

In Example 3, the subject matter of Example 2 optionally includes splitting the first remaining stream portion of the quantum entangled particles at the intermediate node into an intermediate stream portion and an intermediate remaining stream portion of the quantum entangled particles; wherein transmitting the stream of the quantum entangled particles to at least the second node includes transmitting the intermediate remaining stream portion from the intermediate node to the second node.

In Example 4, the subject matter of Example 3 optionally includes wherein splitting the stream of quantum entangled particles at the first node comprises using a first beamsplitter at the first node, and wherein splitting the stream of quantum entangled particles at the intermediate node comprises using an intermediate beamsplitter at the intermediate node.

In Example 5, the subject matter of any one or more of Examples 1-4 optionally include wherein the first node, the second node, and the intermediate node are respective satellites in the satellite communication network.

In Example 6, the subject matter of any one or more of Examples 1-5 optionally include wherein at least one of the first node and the second node are located on-Earth while connected to the satellite communication network.

In Example 7, the subject matter of any one or more of Examples 1-6 optionally include wherein an observation of the quantum entangled particles occurs exclusively at the first node and the second node to derive the quantum entangled value.

In Example 8, the subject matter of any one or more of Examples 1-7 optionally include wherein the intermediate node is a quantum networking repeater, wherein the quantum networking repeater uses entanglement swapping to establish an entanglement between (i) a first set of entangled particles exchanged between the first node and the intermediate node and (ii) a second set of entangled particles exchanged between the intermediate node and the second node.

In Example 9, the subject matter of any one or more of Examples 1-8 optionally include wherein the cryptographic protocol includes use of a random number produced from a quantum-derived seed as input to a random number generator, and wherein the quantum-derived seed is based on the quantum entangled value.

In Example 10, the subject matter of Example 9 optionally includes wherein the random number generator produces the random number based on measurements of the quantum-derived seed from the quantum entangled particles, and wherein the first node measures a first particle in a pair of quantum entangled particles and wherein the second node measures a second particle in the pair of quantum entangled particles.

In Example 11, the subject matter of Example 10 optionally includes wherein the measurements of the quantum-derived seed are based on measuring a spin state for each electron in a stream of entangled electron pairs, and wherein each measurement provides a corresponding bit value of the random number.

In Example 12, the subject matter of any one or more of Examples 10-11 optionally include wherein the measurements of the quantum-derived seed are based on detecting a path of single photons sent through a beamsplitter having two output paths, wherein detecting a first single photon at a first output path of the beamsplitter provides a first bit value of the random number, and wherein detecting a second single photon at a second output path of the beamsplitter provides a second bit value of the random number, the first bit value being different than the second bit value.

In Example 13, the subject matter of any one or more of Examples 10-12 optionally include wherein the measurements of the quantum-derived seed are based on measuring a polarization state for each photon in a stream of entangled photon pairs, and wherein each measurement provides a corresponding bit value for the random number.

In Example 14, the subject matter of any one or more of Examples 10-13 optionally include wherein the measurements of the quantum-derived seed are based on recording a series of arrival times of a stream of photons at a detector, and wherein a difference or variation in arrival time between subsequent single photons provides a bit value for the random number.

In Example 15, the subject matter of any one or more of Examples 10-14 optionally include wherein the measurements of the quantum-derived seed are based on measuring decay times of a radioactive isotope, and wherein a difference or variation in decay time between successive decay events of the radioactive isotope provides a bit value for the random number.

In Example 16, the subject matter of any one or more of Examples 10-15 optionally include wherein the quantum entangled particles comprise a pair of entangled qubits, wherein the measurements of the quantum-derived seed are based on measuring a phase of one qubit of the pair of entangled qubits at different evolution times, and wherein an output of measuring the phase is quantified to provide a bit value for the random number.

In Example 17, the subject matter of any one or more of Examples 1-16 optionally include generating another stream of quantum entangled particles; and transmitting at least part of the another stream of the quantum entangled particles to at least a third node and another intermediate node connected via the satellite communication network, wherein the another intermediate node is located between the second node and the third node; wherein the another stream of the quantum entangled particles is used to derive another quantum entangled value for use with the cryptographic protocol of secure communications between the second node and the third node via the satellite communication network.

In Example 18, the subject matter of Example 17 optionally includes wherein use of the cryptographic protocol of secure communications between the first node and the second node, and between the second node and the third node, is used to establish secure communications between the first node and the third node.

Example 19 is at least one non-transitory machine-readable medium including instructions, which when executed by processing circuitry of a first node in a computing network, cause the processing circuitry to perform operations comprising: generating a stream of quantum entangled particles; and transmitting at least part of the stream of the quantum entangled particles to at least a first node, a second node, and an intermediate node connected via a satellite communication network, wherein the intermediate node is located between the first node and the second node; wherein the stream of the quantum entangled particles is used to derive a quantum entangled value for use with a cryptographic protocol of secure communications between the first node and the second node via the satellite communication network.

Example 20 is a node in a computing network, the node comprising: processing circuitry; and memory, including instructions, which when executed by the processing circuitry, cause the processing circuitry to perform operations to: control generation of a stream of quantum entangled particles; and control transmission of at least part of the stream of the quantum entangled particles to at least a first node, a second node, and an intermediate node connected via a satellite communication network, wherein the intermediate node is located between the first node and the second node; wherein the stream of the quantum entangled particles is used to derive a quantum entangled value for use with a cryptographic protocol of secure communications between the first node and the second node via the satellite communication network.

Example 21 is at least one machine-readable medium including instructions that, when executed by processing circuitry, cause the processing circuitry to perform operations to implement or use of any of Examples 1-20.

Example 20 is an apparatus comprising means to implement or use of any of Examples 1-20.

Example 21 is a system to implement of any of Examples 1-20.

Example 22 is a method to implement of any of Examples 1-20.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described.

However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A method for establishing secure communications with quantum entanglement, comprising:
generating a stream of quantum entangled particles; and
transmitting at least part of the stream of the quantum entangled particles to at least a first node, a second node, and an intermediate node connected via a satellite communication network, wherein the intermediate node is located between the first node and the second node;
wherein the stream of the quantum entangled particles is used to derive a quantum entangled value for use with a cryptographic protocol of secure communications between the first node and the second node via the satellite communication network.

2. The method of claim 1, further comprising:
splitting the stream of quantum entangled particles at the first node into a first stream portion and a first remaining stream portion of the quantum entangled particles,
wherein transmitting the stream of the quantum entangled particles to at least the second node includes transmitting at least part of the first remaining stream portion from the first node to the intermediate node.

3. The method of claim 2, further comprising:
splitting the first remaining stream portion of the quantum entangled particles at the intermediate node into an intermediate stream portion and an intermediate remaining stream portion of the quantum entangled particles;
wherein transmitting the stream of the quantum entangled particles to at least the second node includes transmitting the intermediate remaining stream portion from the intermediate node to the second node.

4. The method of claim 3, wherein splitting the stream of quantum entangled particles at the first node comprises using a first beamsplitter at the first node, and wherein splitting the stream of quantum entangled particles at the intermediate node comprises using an intermediate beamsplitter at the intermediate node.

5. The method of claim 1, wherein the first node, the second node, and the intermediate node are respective satellites in the satellite communication network.

6. The method of claim 1, wherein at least one of the first node and the second node are located on-Earth while connected to the satellite communication network.

7. The method of claim 1, wherein an observation of the quantum entangled particles occurs exclusively at the first node and the second node to derive the quantum entangled value.

8. The method of claim 1, wherein the intermediate node is a quantum networking repeater, wherein the quantum networking repeater uses entanglement swapping to establish an entanglement between (i) a first set of entangled particles exchanged between the first node and the intermediate node and (ii) a second set of entangled particles exchanged between the intermediate node and the second node.

9. The method of claim 1, wherein the cryptographic protocol includes use of a random number produced from a quantum-derived seed as input to a random number generator, and wherein the quantum-derived seed is based on the quantum entangled value.

10. The method of claim 9, wherein the random number generator produces the random number based on measurements of the quantum-derived seed from the quantum entangled particles, and wherein the first node measures a first particle in a pair of quantum entangled particles and wherein the second node measures a second particle in the pair of quantum entangled particles.

11. The method of claim 10, wherein the measurements of the quantum-derived seed are based on measuring a spin state for each electron in a stream of entangled electron pairs, and wherein each measurement provides a corresponding bit value of the random number.

12. The method of claim 10, wherein the measurements of the quantum-derived seed are based on detecting a path of single photons sent through a beamsplitter having two output paths, wherein detecting a first single photon at a first output path of the beamsplitter provides a first bit value of the random number, and wherein detecting a second single photon at a second output path of the beamsplitter provides a second bit value of the random number, the first bit value being different than the second bit value.

13. The method of claim 10, wherein the measurements of the quantum-derived seed are based on measuring a polarization state for each photon in a stream of entangled photon pairs, and wherein each measurement provides a corresponding bit value for the random number.

14. The method of claim 10, wherein the measurements of the quantum-derived seed are based on recording a series of arrival times of a stream of photons at a detector, and wherein a difference or variation in arrival time between subsequent single photons provides a bit value for the random number.

15. The method of claim 10, wherein the measurements of the quantum-derived seed are based on measuring decay times of a radioactive isotope, and wherein a difference or variation in decay time between successive decay events of the radioactive isotope provides a bit value for the random number.

16. The method of claim 10, wherein the quantum entangled particles comprise a pair of entangled qubits, wherein the measurements of the quantum-derived seed are based on measuring a phase of one qubit of the pair of entangled qubits at different evolution times, and wherein an output of measuring the phase is quantified to provide a bit value for the random number.

17. The method of claim 1, further comprising:
generating another stream of quantum entangled particles; and
transmitting at least part of the another stream of the quantum entangled particles to at least a third node and another intermediate node connected via the satellite communication network, wherein the another intermediate node is located between the second node and the third node;
wherein the another stream of the quantum entangled particles is used to derive another quantum entangled value for use with the cryptographic protocol of secure communications between the second node and the third node via the satellite communication network.

18. The method of claim 17, wherein use of the cryptographic protocol of secure communications between the first node and the second node, and between the second node and the third node, is used to establish secure communications between the first node and the third node.

19. At least one non-transitory machine-readable medium including instructions, which when executed by processing circuitry of a first node in a computing network, cause the processing circuitry to perform operations comprising:
generating a stream of quantum entangled particles; and
transmitting at least part of the stream of the quantum entangled particles to at least a first node, a second node, and an intermediate node connected via a satellite communication network, wherein the intermediate node is located between the first node and the second node;
wherein the stream of the quantum entangled particles is used to derive a quantum entangled value for use with a cryptographic protocol of secure communications between the first node and the second node via the satellite communication network.

20. A node in a computing network, the node comprising:
processing circuitry; and
memory, including instructions, which when executed by the processing circuitry, cause the processing circuitry to perform operations to:
control generation of a stream of quantum entangled particles; and
control transmission of at least part of the stream of the quantum entangled particles to at least a first node, a second node, and an intermediate node connected via a satellite communication network, wherein the intermediate node is located between the first node and the second node; wherein the stream of the quantum entangled particles is used to derive a quantum entangled value for use with a cryptographic protocol of secure communications between the first node and the second node via the satellite communication network.
